(19) United States
(12) Patent Application Publication
(10) Pub. No.: US 2013/0059244 A1
(43) Pub. Date: Mar. 7, 2013

(54) SILICA PARTICLES, ELECTROSTATIC IMAGE DEVELOPING TONER, DEVELOPER FOR DEVELOPING ELECTROSTATIC IMAGES, AND METHOD OF FORMING IMAGES

(71) Applicants: Takeshi IWANAGA, Kanagawa (JP); Yoshifumi ERI, Kanagawa (JP); Emi MATSUSHITA, Kanagawa (JP); Junichi TOMONAGA, Kanagawa (JP); Masakazu IIJIMA, Tokyo (JP)

(72) Inventors: Takeshi IWANAGA, Kanagawa (JP); Yoshifumi ERI, Kanagawa (JP); Emi MATSUSHITA, Kanagawa (JP); Junichi TOMONAGA, Kanagawa (JP); Masakazu IIJIMA, Tokyo (JP)

(73) Assignee: FUJI XEROX CO., LTD., Tokyo (JP)

(21) Appl. No.: 13/367,869

(22) Filed: Feb. 7, 2012

(30) Foreign Application Priority Data
Sep. 1, 2011 (JP) 2011-191108

(51) Int. Cl. G03G 9/00; G03G 9/087; B32B 5/16; G03G 15/08

(52) U.S. Cl. 430/105; 430/108.7; 428/402; 399/252

(57) ABSTRACT

Silica particles have a volume average particle diameter in a range of from about 80 nm to about 300 nm, an average degree of circularity in a range of from about 0.920 to about 0.935, and a geometric standard deviation of the degree of circularity in a range of from about 1.02 to about 1.15.

### CROSS-REFERENCE TO RELATED APPLICATIONS

This application is based on and claims priority under USC 119 from Japanese Patent Application No. 2011-191108 filed Sep. 1, 2011.

### BACKGROUND

1. Technical Field

The present invention relates to silica particles, an electrostatic image developing toner, a developer for developing electrostatic images, and a method of forming images.

2. Related Art

In recent years, the electrophotographic process has been widely used not only for copiers but also for network printers in offices, personal computer printers, printers for on-demand printing, and the like due to development of devices or well-organized communication network in the information-oriented society, and there has been an increasingly strong demand for high image quality, high speed, high reliability, reduced size, reduced weight, and energy-saving performance for both black and white printing and color printing.

Generally, the electrophotographic process forms a fixed image by undergoing plural processes, such as electrically forming a latent image (electrostatic image) on a photoreceptor (latent image holding member) made of a photoconductive material using a variety of units, developing the latent image using a toner, transferring the toner image on the photoreceptor to a transfer medium, such as paper, through or without an intermediate transfer member, and then fixing the transferred image on the transfer medium.

### SUMMARY

According to an aspect of the invention, there are provided silica particles containing the silica particles having a volume average particle diameter in a range of from about 80 nm to about 300 nm, an average degree of circularity in a range of from about 0.920 to about 0.935, and a geometric standard deviation of the degree of circularity in a range of from about 1.02 to about 1.15.

### BRIEF DESCRIPTION OF THE DRAWINGS

Exemplary embodiments of the present invention will be described in detail based on the following figures, wherein:

FIG. 1 is a schematic configuration view showing an example of an image forming apparatus of an exemplary embodiment; and

FIG. 2 is a schematic configuration view showing an example of a process cartridge of the exemplary embodiment.

### DETAILED DESCRIPTION

Hereinafter, exemplary embodiments of the silica particles and the toner according to an aspect of the invention will be described in detail.

<Silica Particles and Method of Manufacturing the Same>

The silica particles of the exemplary embodiment have a volume average particle diameter of from 80 nm to 300 nm (or from about 80 nm to about 300 nm), an average degree of circularity of from 0.92 to 0.935 (or from about 0.92 to about 0.935), and a geometric standard deviation of the degree of circularity of from 1.02 to 1.15 (or from about 1.02 to about 1.15).

Hitherto, an external additive having a relatively large diameter (for example, from 80 nm to 300 nm) has been used for toner in order to improve the transfer properties of the toner. In addition, spherical toner has been used to efficiently increase the transfer properties particularly in a system for which tertiary transfer is required. The large-diameter external additive that has been used so far was spherical and excellent in terms of the initial transfer properties of toner, but there were cases in which the large-diameter external additive was liable to roll particularly in spherical toner having a small number of recessed portions due to the stress of a developing device. In this case, it was likely that the large-diameter external additive was attached on a carrier or a large proportion of the large-diameter external additive was remained on a photoreceptor, and, particularly, when many images were continuously printed in a high image density state, there were cases in which occurrence of scratch damage to the photoreceptor was caused by deterioration of the charging stability or the large-diameter external additive.

The present inventors and the like found that the above problems may be addressed and the transfer durability properties may be improved by using the silica particles of the exemplary embodiment which shows a specific volume average particle size, average degree of circularity, and geometric standard deviation of the degree of circularity as an external additive.

The silica particles of the exemplary embodiment show a specific geometric standard deviation of the degree of circularity, which suggests that the distribution of the degree of circularity of the silica particles is appropriately wide. Therefore, a particle group of silica particles, which remain on the toner surface, have transfer durability properties, and also keeping charges, and a particle group of silica particles having a function, in which the silica particles roll and randomly move from the toner surface so as to remain on the photoreceptor, thereby assisting toner transfer and keeping transfer, coexist, and thus it is inferred that the silica particles become effective for transfer durability.

In addition, it is inferred that, when the particle diameter of the silica particles is increased to an appropriate range, it is possible to prevent the silica particles from being detached from the toner to a certain amount, the silica particles become effective in exhibiting the transfer properties, the silica particles is prevented from being detached to an excessive amount, and occurrence of filming may be prevented.

In the exemplary embodiment, the volume average particle diameter of the silica particles is from 80 nm to 300 nm. When the volume average particle diameter of the silica particles is less than 80 nm, there are cases in which transferring properties, which is the largest effect of the large-diameter external additive, are not improved. In such cases, toner burial becomes significant due to stirring stress in the developing device during practical use, and the cases are not preferable from the viewpoint of the transfer durability. When the volume average particle diameter of the silica particles exceeds 300 nm, a large number of toner particles are detached even when the distribution of the degree of circularity of the silica particles is large, and there are cases in which problems represented by filming occur.

The volume average particle diameter of the silica particles is preferably from 100 nm to 200 nm (or from about 100 nm to about 200 nm), and more preferably from 100 nm to 150 nm (or from about 100 nm to about 150 nm).

The volume average particle diameter of the silica particles is measured using an LS coulter (particle size measuring apparatus manufactured by Beckman Coulter Inc.). The particle size distribution of the measured particles is defined as follows: the cumulative distribution of the volumes of the respective particles is drawn from the small diameter side for each of the divided particle size ranges (channels), and the particle diameter at a cumulative value of 50% is defined as the volume average particle diameter (D50v).

In the exemplary embodiment, the average degree of circularity of the silica particles is from 0.92 to 0.935. When the average degree of circularity of the silica particles is less than 0.92, there are cases in which the function of assisting transfer is poor, and the transfer durability is not improved. When the average degree of circularity of the silica particles is more than 0.935, the silica particles are violently detached from toner particles, and there are cases in which filming is liable to occur.

The average degree of circularity of the silica particles is preferably from 0.92 to 0.93 (or from about 0.92 to about 0.93).

The degree of circularity of the silica particles (primary particles) is obtained as follows: after the silica particles are dispersed in resin particles (polyester, weight average molecular weight Mw=50000) having a particle diameter of 100 μm, primary particles are observed using a SEM apparatus, and “100/SF2” is computed from the image analysis of the obtained primary particles using the following formula (I).

Degree of circularity(100/SF2)=4π×(A/I²) Formula (I)

[In formula (I), I represents the boundary length of the primary particle in an image, and A represents the projected area of the primary particle.]

The average degree of circularity of the silica particles is obtained from the 50% degree of circularity in the cumulative frequency of the circle equivalent diameter of 100 primary particles, which is obtained by the image analysis.

In the exemplary embodiment, the geometric standard deviation of the degree of circularity of the silica particles is from 1.02 to 1.15. When the geometric standard deviation of the degree of circularity of the silica particles is less than 1.02, the silica particles detaching from toner significantly decreases, and there are cases in which the transfer durability becomes poor. When the geometric standard deviation of the degree of circularity of the silica particles exceeds 1.15, all of the particles become liable to detach from toner, and there are cases in which image defects occur.

The geometric standard deviation of the degree of circularity of the silica particles is preferably from 1.10 to 1.15 (or from about 1.10 to about 1.15).

The geometric standard deviation of the degree of circularity of the silica particles refers to a value obtained by the following method.

Similarly to the average degree of circularity, the 16% degree of circularity and the 84% degree of circularity in the cumulative frequency of the circle equivalent diameter of 100 primary particles, which are obtained by the image analysis, are used, and the square root of (the 84% degree of circularity/16% degree of circularity) is used as the geometric standard deviation of the degree of circularity.

The silica particles of the exemplary embodiment include fumed silica, sol-gel silica, and the like.

The silica particles of the exemplary embodiment may be obtained by any manufacturing method as long as the silica particles show the above specific volume average particle diameter, average degree of circularity, and geometric standard deviation of the degree of circularity. Hereinafter, an example of a method of manufacturing sol-gel silica satisfying the above specific numerical ranges will be shown.

The method of manufacturing sol-gel silica has a silica particle-forming process for forming silica particles by dropping tetraalkoxysilane in an alkali catalyst solution including an alcohol and an alkali catalyst.

The alkali catalyst solution is prepared by undergoing a process for preparing the alkali catalyst solution including an alkali catalyst in a solvent which includes an alcohol (hereinafter sometimes referred to as the “alkali catalyst solution preparation process”).

The silica particles are formed by supplying (dropping) tetraalkoxysilane in the alkali catalyst solution, but the alkali catalyst may be preferably supplied to the alkali catalyst solution together with tetraalkoxysilane.

That is, in the manufacturing method, tetraalkoxysilane is caused to react while tetraalkoxysilane, which is a raw material, and, according to separate necessity, the alkali catalyst, which is a catalyst, are supplied in the presence of an alcohol including the alkali catalyst, and thus silane particles are formed.

In the present method of manufacturing the silica particles, the silica particles are obtained in which little coarse agglomeration occurs.

Here, it is considered that the supply amount of the tetraalkoxysilane has a relationship with the particle size distribution or degree of circularity of the silica particles. It is considered that, when the supply amount of the tetraalkoxysilane is set to from 0.1 part by mass/min to 5.0 parts by mass/min with respect to 100 parts of the alkali catalyst solution, the contact probability between the dropped tetraalkoxysilane and nucleus particles is decreased, and the tetraalkoxysilane is uniformly supplied to the nucleus particles before a reaction among the tetraalkoxysilanes occurs. Therefore, it is considered that the reaction between the tetraalkoxysilane and the nucleus particles may be uniformly caused. As a result, it is considered that variation of particle growth is suppressed.

Meanwhile, it is considered that the volume average particle diameter of the silica particles is dependent on the total supply amount of the tetraalkoxysilane.

In addition, in the present method of manufacturing the silica particles, since the tetraalkoxysilane and, according to necessity, the alkali catalyst are supplied to the alkali catalyst solution so as to cause a reaction of the tetraalkoxysilane and thus form particles, compared with a case in which silica particles are manufactured by the sol-gel method of the related art, the total used amount of the alkali catalyst is decreased, and, consequently, a process for removing the alkali catalyst may not be required. This is advantageous particularly in a case in which the silica particles are applied to products for which a high purity is required.

Next, the alkali catalyst solution preparation process will be described.

In the alkali catalyst solution preparation process, a solvent including an alcohol is prepared, and an alkali catalyst is added thereto, thereby preparing an alkali catalyst solution.

The solvent including an alcohol may be a pure alcohol solvent, and may be, according to necessity, a mixed solvent of an alcohol and another solvent, such as water, a ketone (for example, acetone, methyl ethyl ketone, methyl isobutyl ketone, or the like), a cellosolve (for example, methyl cellosolve, ethyl cellosolve, butyl cellosolve, cellosolve acetate, or the like), an ether (for example, dioxane, tetrahydrofuran, or the like), or the like. In the case of the mixed solvent, the amount of alcohol with respect to the other solvent is preferably 80% by mass or more (desirably 90% by mass or more).

Meanwhile, examples of the alcohol include lower alcohols, such as methanol and ethanol.

On the other hand, the alkali catalyst is a catalyst for promoting the reaction (hydrolysis reaction, condensation reaction) of the tetraalkoxysilane. Examples thereof include basic catalysts, such as ammonia, urea, monoamine, quaternary ammonium salts, and the like, and ammonia is particularly desirable.

The concentration (content) of the alkali catalyst is from 0.6 mol/L to 0.87 mol/L, desirably from 0.63 mol/L to 0.78 mol/L, and more desirably from 0.66 mol/L to 0.75 mol/L.

When the concentration of the alkali catalyst is 0.6 mol/L or more, the dispersibility of the nucleus particles becomes stable while the formed nucleus particles grow, coarse agglomeration, such as secondary agglomerate, is prevented from being formed or gelatinized, and deterioration of the particle size distribution is suppressed.

On the other hand, when the concentration of the alkali catalyst is 0.87 mol/L or less, the stability of the formed nucleus particles does not become excessive, truly spherical nucleus particles are not formed, and it becomes easy to obtain nucleus particles having an average degree of circularity of 0.92 to 0.935.

Meanwhile, the concentration of the alkali catalyst is a concentration in the alcohol catalyst solution (the alkali catalyst+the solvent including an alcohol).

The silica particle formation process will be described.

The silica particle formation process is a process in which the tetraalkoxysilane and, according to necessity, the alkali catalyst are supplied (dropped) to the alkali catalyst solution, and a reaction (hydrolysis reaction, condensation reaction) of the tetraalkoxysilane is caused in the alkali catalyst solution, thereby forming silica particles.

In the silica particle formation process, nucleus particles are formed by the reaction of the tetraalkoxysilane at the initial phase of the supply of the tetraalkoxysilane (nucleus particle formation phase), and then the nucleus particles are grown (nucleus particle growth phase), thereby forming silica particles.

Examples of the tetraalkoxysilane supplied to the alkali catalyst solution include tetramethoxysilane, tetraethoxysilane, tetrapropoxysilane, tetrabuthoxysilane, and the like, and tetramethoxysilane and tetraethoxysilane are preferable in terms of the controllability of the reaction rate or the shape, particle diameter, particle size distribution, and the like of the obtained silica particles.

The supply amount of the tetraalkoxysilane is not particularly limited; however, for example, is set to from 0.1 part by mass/min to 3.0 parts by mass/min with respect to 100 parts by mass of the alkali catalyst solution.

In a case in which the tetraalkoxysilane is supplied at plural dropping locations, the total amount of the supply amounts at the respective dropping locations is set in the above range.

Meanwhile, the particle diameter of the silica particles may be easily adjusted by adjusting the total supply amount of the tetraalkoxysilane which is used for the reaction of particle formation while the particle diameter of the silica particles is dependent on the type or reaction conditions of the tetraalkoxysilane.

Meanwhile, the alkali catalyst supplied to the alkali catalyst solution includes substances as exemplified above.

The alkali catalyst being supplied may be the same type as an alkali catalyst which is previously included in the alkali catalyst solution or a different type, but the same type catalyst is preferable.

The supply amount of the alkali catalyst is preferably from 0.1 part by mass/min to 1.5 parts by mass/min, and more preferably from 0.2 part by mass/min to 1.0 part by mass/min with respect to 100 parts by mass of the alkali catalyst solution.

Here, in the silica particle formation process, the tetraalkoxysilane and, according to necessity, the alkali catalyst are supplied to the alkali catalyst solution, but the supplying method may be a continuous supplying mode or an intermittent supplying mode.

In the exemplary embodiment, the tetraalkoxysilane is preferably dropped to the alkali catalyst solution at a minimum of 2 locations so as to form silica particles. In this case, the ratio of the drop amount at a dropping location at which the maximum amount of the tetraalkoxysilane is dropped (maximum drop amount) to the drop amount at a dropping location at which the minimum amount of the tetraalkoxysilane is dropped (minimum drop amount) (maximum drop amount/minimum drop amount) is preferably from 1 to 5, and more preferably from 1.5 to 4. When the drop amount ratio (maximum drop amount/minimum drop amount) is from 1 to 5, it is possible to control the distribution of the degree of circularity of the silica particles in a desirable state.

In the silica particle formation process, the temperature of the alkali catalyst solution (the temperature during the supply) is, for example, preferably from 5° C. to 50° C., and desirably in a range of from 15° C. to 40° C.

The silica particles may be obtained by undergoing the above processes. In this state, the silica particles to be obtained are obtained in a dispersion state, and the silica particles may be used as a silica particle dispersion as it is, or may be used after the solvent is removed so as to produce the powder of the silica particles.

In a case in which the silica particles are used in the form of the silica particle dispersion, the solid state concentration of the silica particles may be adjusted by diluting the silica particles using water or an alcohol, according to necessity, or condensing the silica particles.

In addition, the silica particle dispersion may be used after the solvent is substituted with other aqueous organic solvent, such as an alcohol, an ester, or a ketone.

The method of removing the solvent from the silica particle dispersion includes known methods, such as 1) a method in which the solvent is removed through filtration, centrifugation, distillation, or the like, and then the product is dried using a vacuum dryer, a shelf dryer, or the like, and 2) a method in which slurry is directly dried using a fluid-bed dryer, a spray dryer, or the like. The drying temperature is not particularly limited, but is desirably 200° C. or lower. When the drying temperature is higher than 200° C., bonding of primary particles or formation of coarse particles is likely to occur due to condensation of silanol groups that remain on the surfaces of the silica particles.

According to necessity, coarse particles or agglomeration may be removed from the dried silica particles through crushing or sieving. The crushing method is not particularly limited, and, for example, a dry crushing apparatus, such as a jet mill, a vibration mill, a ball mill, or a pin mill, is used. Sieving is carried out using a known apparatus, for example, a shaking sieve, a wind classifier, or the like.

The silica particles obtained by the present method of manufacturing silica particles may be used after the surfaces of the silica particles are hydrophobized using a hydrophobizing agent.

Examples of the hydrophobizing agent include known organic silicon compounds having an alkyl group (for example, a methyl group, an ethyl group, a propyl group, a butyl group, or the like), and specific examples thereof include silazane compounds (for example, silane compounds, such as methyltrimethoxysilane, dimethyldimethoxysilane, trimethylchlorosilane, and trimethylmethoxysilane, hexamethyldisilazane, tetramethyldisilazane, or the like). The hydrophobizing agent may be used singly, or plural agents may be used.

Among the hydrophobizing agents, organic silicon compounds having a trimethyl group, such as trimethylmethoxysilane and hexamethyldisilazane, are preferable.

The used amount of the hydrophobizing agent is not particularly limited; however, for example, is preferably from 1% by mass to 100% by mass, and desirably from 5% by mass to 80% by mass with respect to the silica particles in order to obtain the hydrophobizing effect.

Examples of the method of producing a hydrophobic silica particle dispersion that is hydrophobized using the hydrophobizing agent include a method in which a hydrophobizing treatment is carried out on the silica particles by adding a necessary amount of the hydrophobizing agent to the silica particle dispersion, and causing the hydrophobizing agent to react at a temperature range of from 30° C. to 80° C. while being stirred, thereby producing a hydrophobic silica particle dispersion. When the reaction temperature is lower than 30° C., a hydrophobizing reaction may not easily proceed, and when the reaction temperature exceeds 80° C., there are cases in which gelatinization of the dispersion, agglomeration of silica particles, or the like becomes liable to occur due to the self condensation of the hydrophobcizing agent.

Meanwhile, the method of producing hydrophobic silica particle powder includes a method in which a hydrophobic silica particle dispersion is obtained by the above method, and then dried by the above method, thereby producing hydrophobic silica particle powder, a method in which a silica particle dispersion is dried so as to produce hydrophilic silica particle powder, and then a hydrophobizing treatment is carried out by adding the hydrophobizing agent, thereby producing hydrophobic silica particle powder, a method in which a hydrophobic silica particle dispersion is obtained and dried so as to produce hydrophobic silica particle powder, and then, furthermore, a hydrophobizing treatment is carried out by adding the hydrophobizing agent, thereby producing hydrophobic silica particle powder, and the like.

Here, the method of a hydrophobizing treatment of the silica particle powder includes a method in which the hydrophilic silica particle powder is stirred in a treatment vessel, such as a Henschel mixer or a fluidized bed, a hydrophobizing agent is added thereto, and the inside of the treatment vessel is heated, thereby gasifying the hydrophobizing agent and causing the hydrophobizing agent to react with silanol groups on the surface of the silica particle powder. The treatment temperature is not particularly limited; however, for example, is preferably from 80° C. to 300° C., and desirably from 120° C. to 200° C.

<Toner>

The toner of the exemplary embodiment contains toner particles that include at least a binder resin and have an average degree of circularity of 0.96 or more (or about 0.96 or more), and at least the silica particles of the exemplary embodiment as an external additive.

In the toner of the exemplary embodiment, transfer durability may be improved by jointly using toner particles having an average degree of circularity of 0.96 or more and the silica particles of the exemplary embodiment, which show specific volume average particle diameter, average degree of circularity, and geometric standard deviation of the degree of circularity as an external additive.

In the exemplary embodiment, the average degree of circularity of the toner particles is 0.96 or more. When the average degree of circularity of the toner particles is less than 0.96, the toner itself becomes non-spherical particles, required high transfer efficiency may not be satisfied, and there are cases in which a problem of poor transfer occurs. The average degree of circularity of the toner particles is preferably 0.97 or more (or about 0.97 or more).

The average degree of circularity of the toner particles may be measured using a flow-type particle image analyzing apparatus FPIA-2000 (manufactured by Sysmex Corp.). Specifically, as a dispersant, 0.1 ml to 0.5 ml of a surfactant, preferably an alkylbenzene sulfonate, is added to 100 ml to 150 ml of water from which solid impurities are removed in advance, and, furthermore, approximately 0.1 g to 0.5 g of a measurement sample is added. A dispersion treatment is carried out on a suspension having the measurement sample dispersed therein for 1 minute to 3 minutes using an ultrasonic disperser so as to obtain a dispersion concentration of 3000 particles/μl to 10000 particles/μl, and then the average degree of circularity of the toner is measured.

The toner particles of the exemplary embodiment contain a binder resin, and may include a release agent, a colorant, and other additives according to necessity.

—Binder Resin—

The binder resin will be described.

The binder resin includes amorphous resins, and an amorphous resin and a crystalline resin may be used in combination.

The binder resin includes polyester resins and vinyl resins.

The polyester resin is synthesized from, for example, a polyvalent carboxylic acid and a polyol.

Meanwhile, as the polyester resin, a commercially available product may be used, or a synthesized substance may be used.

The method of manufacturing the polyester resin is not particularly limited, and an ordinary polyester polymerization method in which an acid component and an alcohol component are caused to react with each other may be used to manufacture a polyester resin. Examples thereof include direct polycondensation, transesterification, and the like, and an appropriate method is used depending on the type of monomer.

The polyester resin is manufactured in a polymerization temperature range of from 180° C. to 230° C., the inside of a reaction system is depressurized according to necessity, and a reaction is caused while water or an alcohol, which is generated during condensation, is removed. In a case in which the monomer is not soluble or compatible at the reaction temperature, a high boiling-point solvent is added as a solubilizing agent, and then the monomer is dissolved. In the polycondensation reaction, the reaction proceeds while the solubilizing agent is distilled away. In a case in which poorly compatible monomer is present during the polymerization reaction, the monomer may be copolymerized with the main components after the poorly compatible monomer and an acid or an alcohol, which is to be polycondensed with the monomer, are condensed in advance.

The vinyl resin includes the homopolymers, copolymers, and the like of a monomer, which acts as a raw material of a vinyl polymer acid or a vinyl polymer base, such as styrenes, such as styrene, parachlorostyrene, and α-methylstyrene; esters having a vinyl group, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; vinyl nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; acrylic acids, methacrylic acids, maleic acids, cinnamic acids, fumaric acids, vinyl sulfonic acids, ethyleneimines, vinylpyridine, vinylamine, and the like.

The vinyl resin is advantageous that a resin particle dispersion is easily prepared by emulsification polymerization or seed polymerization using an ionic surfactant and the like.

In a case in which the binder resin has a melting temperature, the melting temperature is desirably from 50° C. to 100° C., and more desirably from 60° C. to 80° C. In addition, in a case in which the binder resin has a glass transition temperature, the glass transition temperature is desirably from 35° C. to 100° C., and more desirably from 50° C. to 80° C.

The melting temperature of the binder resin refers to a value obtained as the peak temperature of the endothermic peak obtained by differential scanning calorimetry (DSC). In addition, there are cases in which the binder resin shows plural endothermic peaks; however, in the exemplary embodiment, the highest peak is considered as the melting temperature.

In addition, the glass transition temperature of the binder resin is obtained as the peak temperature of the endothermic peak obtained by differential scanning calorimetry (DSC).

The polyester resin is preferably manufactured by causing a condensation reaction of the polyol and a polyvalent carboxylic acid by an ordinary method. For example, the polyester resin may be manufactured as follows: the polyol, the polyvalent carboxylic acid, and, according to necessity, a catalyst are put and mixed in a reaction vessel having a thermometer, a stirrer, and a falling condenser, heated at from 150° C. to 250° C. in the presence of an inert gas (nitrogen gas or the like), byproducts of a low molecular compound are continuously removed from the reaction system, the reaction is stopped at a point of time when a specific acid value is reached, and the mixture is cooled, thereby manufacturing a target reaction product.

Here, when the molecular weight is measured by the gel permeation chromatography (GPC) of the soluble proportion of tetrahydrofuran (THF), the weight average molecular weight (Mw) of the binder resin is desirably from 5000 to 1000000, and more desirably from 7000 to 500000, the number average molecular weight (Mn) is desirably from 2000 to 10000, the molecular weight distribution Mw/Mn is desirably from 1.5 to 100, and more desirably from 2 to 60.

The weight average molecular weight of the resin is measured by gel permeation chromatography (GPC). Specifically, the GPC measurement is carried out on HLC-8120 (manufactured by Tosoh Co., Ltd.) equipped with TSKgel Super HM-M (15 cm) (manufactured by Tosoh Co., Ltd.) as a column and using THF as a solvent, and computing the molecular weight using a molecular weight calibration curve prepared using a monodispersed polystyrene standard sample.

In addition, the softening temperature of the binder resin is desirably in a range of from 80° C. to 130° C., and more desirably in a range of from 90° C. to 120° C.

The softening temperature of the binder resin refers to an intermediate temperature between the melting-start temperature and melting-end temperature of a flow tester (CFT-500C, manufactured by Shimadzu Corporation) under conditions of preheating: 80° C./300 sec, plunger pressure: 0.980665 MPa, die size: 1 mmφ×1 mm, and temperature rise rate: 3.0° C./min.

—Colorant—

The colorant, which is used as necessary, will be described.

The content of the colorant in the toner particles may be in a range of from 2% by mass to 15% by mass, and desirably in a range of from 3% by mass to 10% by mass.

The colorant includes known organic or inorganic pigments, dyes, or oil-soluble dyes.

Examples of the black pigment include carbon black, magnetic powder, and the like.

Examples of the yellow pigment include Hansa Yellow, Hansa Yellow 10G, Benzidine Yellow G, Bendizine Yellow GR, Suren Yellow, Quinoline Yellow, Permanent Yellow NCG, and the like.

The red pigment includes Bengala, Watchyoung Red, Permanent Red 4R, Lithol Red, Brilliant Carmine 3B, Brilliant Carmine 6B, DuPont Oil Red, Pyrazolone Red, Rhodamine B Lake, Lake Red C, Rose Bengal, Eoxine Red, Alizarin Lake, and the like.

The blue pigment includes Prussian Blue, cobalt blue, Alkali Blue Lake, Victoria Blue Lake, Fast Sky Blue, Indanthrene Blue BC, Aniline Blue, Ultramarine Blue, Calco Oil Blue, Methylene Blue Chloride, Phthalocyanine Blue, Phthalocyanine Green, Malachite Green Oxalate, and the like.

In addition, these colorants may be used after being mixed, and, furthermore, in a solid solution state.

—Release Agent—

Next, the release agent, which is used as necessary, will be described.

The content of the release agent in the toner particles may be in a range of from 1% by mass to 10% by mass, and more desirably in a range of from 2% by mass to 8% by mass.

As the release agent, a material having a main endothermic peak temperature, which is measured according to ASTM D3418-8, in a range from 50° C. to 140° C. is preferable.

For the measurement of the main endothermic peak temperature, for example, a DSC-7, manufactured by Perkin Elmer, is used. For the temperature correction at the detecting portion of the apparatus, the fusion temperatures of indium and zinc are used, and the fusion heat of indium is used for the calorie correction. An aluminum pan is used as a sample, an empty pan is set for comparison, and measurement is carried out at a temperature rise rate of 10° C./min.

The viscosity η1 of the release agent at 160° C. is preferably in a range of from 20 cps to 600 cps.

Specific examples of the release agent include low molecular weight polyolefins, such as polyethylene, polypropylene, and polybutene; silicones having a softening point by heating; fatty acid amides, such as oleic acid amide, erucic amide, ricinoleic acid amide, and stearic acid amide; plant-based waxes, such as carnauba wax, rice wax, candelilla wax, Japanese wax, and jojoba oil; animal-based waxes, such as beeswax; minerals, such as Montan wax, ozokerite, ceresin, paraffin wax, microcrystalline wax, and Fischer-Tropsch wax; petroleum-based waxes, and denaturants thereof.

—Other Additives—

Other additives will be described.

The other additives include various components, such as an internal additive, a charge controlling agent, an inorganic powder (inorganic particles), organic particles, and the like.

Examples of the internal additive include metals, such as ferrite, magnetite, reduced iron, cobalt, nickel, and manganese, alloys, and magnetic materials, such as compounds including these metals, and the like.

Examples of the inorganic particles include known inorganic particles, such as silica particles, titanium oxide particles, alumina particles, cerium oxide particles, the above particles having the surfaces hydrophobizing-treated, and the like. The inorganic particles may be subjected to various surface treatments, and, for example, inorganic particles that are subjected to a surface treatment using a silane-based coupling agent, a titanium-based coupling agent, a silicone oil, or the like are preferable.

—Properties—

Next, the properties of the toner particles will be described.

The volume average particle diameter D50 of the toner particles is desirably in a range of from 3 μm to 9 μm, and more desirably in a range of from 3 μm to 6 μm.

Meanwhile, the volume average particle diameter is measured using a MULTISIZER II (manufactured by Beckman-Coulter) with an aperture diameter of 50 μm. At this time, the measurement is carried out after the toner is dispersed in an aqueous electrolyte solution (aqueous solution of ISOTON) and dispersed by ultrasonic waves for 30 seconds or more.

(Method of Manufacturing the Toner)

Next, the method of manufacturing the toner of the exemplary embodiment will be described.

Firstly, the toner particles may be manufactured by any of dry manufacturing methods (for example, kneading-pulverization method or the like), and wet manufacturing methods (for example, aggregation method, suspension polymerization method, dissolution suspension granulation method, dissolution suspension method, dissolution emulsification aggregation method, and the like). The manufacturing methods are not particularly limited, and a well-known manufacturing method is employed.

In addition, the toner of the exemplary embodiment is manufactured by, for example, adding the silica particles of the exemplary embodiment as an external additive to the obtained toner particles, and mixing the two. The mixing is preferably carried out using, for example, a V blender, a Henschel mixer, a Loedige mixer, or the like. Furthermore, according to necessity, coarse particles of the toner may be removed using an oscillation sieve, a wind power sieve, or the like.

<Electrostatic Image Developer>

The electrostatic image developer of the exemplary embodiment includes at least the toner of the exemplary embodiment.

The electrostatic image developer of the exemplary embodiment may be a single-component developer including the toner of the exemplary embodiment only or a two-component developer in which the toner of the exemplary embodiment is mixed with a carrier.

The carrier is not particularly limited, and includes known carriers. Examples of the carrier include a resin-coated carrier, a magnetic particles dispersed carrier and the like.

The mixing ratio (mass ratio) of the toner of the exemplary embodiment to the carrier in the two-component developer is desirably in a range of from 1:100 to 30:100, and more desirably in a range of from about 3:100 to 20:100.

<Image Forming Apparatus>

Next, an image forming apparatus and an image forming method of the exemplary embodiment will be described.

The image forming apparatus of the exemplary embodiment has a latent image holding member, a charging unit that charges the surface of the latent image holding member, an electrostatic image forming unit that forms an electrostatic image on the surface of the charged latent image holding member, a developing unit that accommodates the electrostatic image developer, and develops the electrostatic image formed on the surface of the latent image holding member using the electrostatic image developer into a toner image, a transferring unit that transfers the toner image formed on the surface of the latent image holding member onto a transfer medium, and a fixing unit that fixes the toner image transferred onto the transfer medium. In addition, the electrostatic image developer of the exemplary embodiment is applied as the electrostatic image developer.

According to the image forming apparatus according to this exemplary embodiment, an image forming method is performed that includes: a charging process of charging a surface of an image holding member; an electrostatic latent image forming process of forming an electrostatic latent image on the charged surface of the image holding member; a developing process of developing the electrostatic latent image formed on the surface of the image holding member by using the developer for electrostatic charge development according to this exemplary embodiment to form a toner image; and a transfer process of transferring the developed toner image onto a transfer medium.

Meanwhile, in the image forming apparatus of the exemplary embodiment, for example, the portion that includes the developing unit may have a cartridge structure (process cartridge) that is detachable from the image forming apparatus, and a process cartridge having the developing unit which accommodates the electrostatic image developer of the exemplary embodiment is preferably used as the process cartridge. In addition, in the image forming apparatus, for example, a portion that accommodates a supplemental toner may have a cartridge structure (toner cartridge) that is detachable from the image forming apparatus, and a toner cartridge that accommodates the toner of the exemplary embodiment is preferably applied as the toner cartridge.

Hereinafter, an example of the image forming apparatus of the exemplary embodiment will be shown, but the invention is not limited thereto. Meanwhile, the mainly used portions as shown in the drawings will be described, and other portions will not be described.

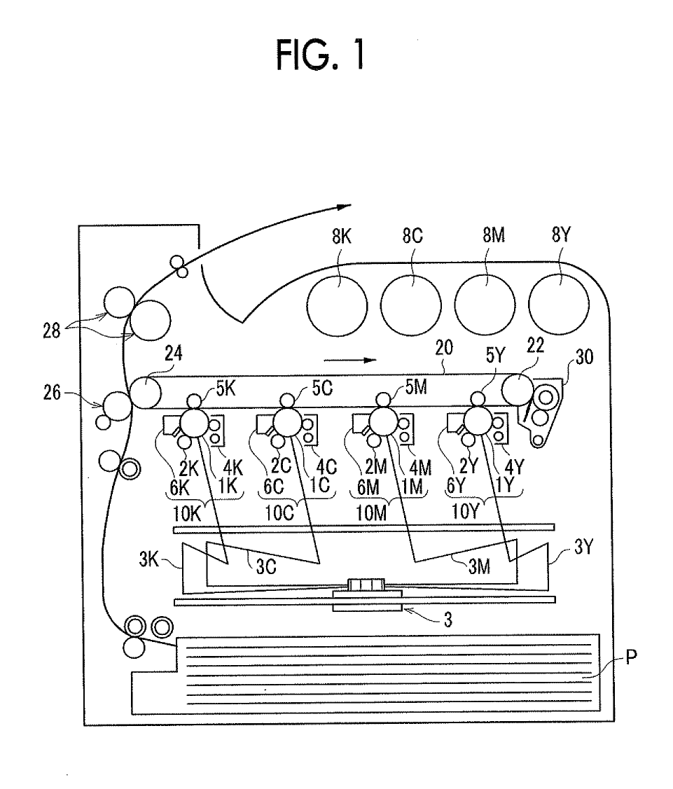

FIG. 1 is a schematic configuration view showing a 4-drum tandem image forming apparatus, which is an example of the image forming apparatus of the exemplary embodiment. The image forming apparatus as shown in FIG. 1 has first to fourth image forming units 10Y, 10M, 10C, and 10K (image forming unit) in an electrophotographic mode which output images of the respective colors of yellow (Y), magenta (M), cyan (C), and black (K) based on color-separated image data. The image forming units (hereinafter referred to simply as “units”) 10Y, 10M, 10C, and 10K are provided in parallel at a predetermined interval in the horizontal direction. Meanwhile, the units 10Y, 10M, 10C, and 10K may be process cartridges that may be attached to and detached from the main body of the image forming apparatus.

An intermediate transfer belt 20 is provided as an intermediate transfer member above the respective units 10Y, 10M, 10C, and 10K in the drawing. The intermediate transfer belt 20 is supported by a driving roller 22 and a supporting roller 24 that is in contact with the inner surface of the intermediate transfer belt 20, both of which are disposed away from each other from left to right in the drawing so as to run in the direction from the first unit 10Y to the fourth unit 10K. Further, the supporting roller 24 is pushed with a spring and the like, not shown, away from the driving roller 22, and a predetermined tension is supplied to the intermediate transfer belt 20 supported by both rollers. In addition, an intermediate transfer member cleaning apparatus 30 is provided on the side surface of the image holding member of the intermediate transfer belt 20, opposite to the driving roller 22.

In addition, developing apparatuses (developing unit) 4Y, 4M, 4C, and 4K of the respective units 10Y, 10M, 10C, and 10K are supplied with toners of 4 colors of yellow, magenta, cyan, and black, which are accommodated in toner cartridges 8Y, 8M, 8C, and 8K.

Since the first to fourth units 10Y, 10M, 10C and 10K have the same configuration, here, the first unit 10Y that forms an yellow image, which is disposed on the upper stream side in the running direction of the intermediate transfer belt, will be described as a representative example. Further, to the equivalent portions in the first unit 10Y, reference symbols of magenta (M), cyan (C), and black (K) will be given instead of yellow (Y), and the description on the second to fourth units 10M, 10C, and 10K will not be made.

The first unit 10Y has a photoreceptor 1Y which functions as a latent image holding member. Around the photoreceptor 1Y, a charging roller 2Y that charges the surface of the photoreceptor 1Y to a predetermined electrical potential, an exposing apparatus 3 that makes the charged surface exposed to a laser beam 3Y based on a color-separated image signal so as to form an electrostatic image, a developing apparatus (developing unit) 4Y that supplies charged toner to the electrostatic image so as to develop an electrostatic image, a primary transfer roller (primary transfer unit) 5Y that transfers the developed toner image onto the intermediate transfer belt 20, and a photoreceptor cleaning apparatus (removing unit) 6Y that removes the toner remaining on the surface of the photoreceptor 1Y after the primary transfer are provided.

Further, the primary transfer roller 5Y is disposed inside the intermediate transfer belt 20 at a position opposite to the photoreceptor 1Y. Furthermore, a bias power supply (not shown) that applies a primary transfer bias is connected to each of the primary transfer rollers 5Y, 5M, 5C, and 5K. Each of the bias power supply varies the transfer bias applied to each of the primary transfer rollers by the control of a control portion (not shown).

Hereinafter, an operation for forming a yellow image in the first unit 10Y will be described. Firstly, prior to the operation, the surface of the photoreceptor 1Y is charged to an electrical potential of approximately −600 V to −800 V by the charging roller 2Y.

The photoreceptor 1Y is formed by laminating a photosensitive layer on a conductive (the volume resistivity at 20° C.: 1×10⁻⁶ Ω·cm or less) substrate. Generally, the photosensitive layer has a high resistance (the resistance of an ordinary resin), but has properties in which the specific resistance is changed at portions to which the laser beam 3Y is irradiated when the laser beam is irradiated. Therefore, the laser beam 3Y is output on the surface of the charged photoreceptor 1Y through the exposing apparatus 3 according to image data for yellow which is sent from the control portion, not shown. The laser beam 3Y is irradiated to the photosensitive layer on the surface of the photoreceptor 1Y, whereby an electrostatic image is formed on the surface of the photoreceptor 1Y in a yellow printing pattern.

The electrostatic image is an image formed on the surface of the photoreceptor 1Y by charging, and is a so-called negative latent image which is formed in the following manner: the specific resistance is decreased by the laser beam 3Y at irradiated portions on the photosensitive layer, and charged electric charges on the surface of the photoreceptor 1Y flow, whereas electric charges remain on portions to which the laser beam 3Y is not irradiated.

The electrostatic image formed on the photoreceptor 1Y in the above manner is rotated up to a predetermined developing position as the photoreceptor 1Y runs. In addition, the electrostatic image on the photoreceptor 1Y is made into a visible image (toner image) by the developing apparatus 4Y at the developing position.

The developing apparatus 4Y accommodates the yellow toner of the exemplary embodiment. The yellow toner is stirred in the developing apparatus 4Y so as to be friction-charged, has electric charges of the same polarity (negative polarity) as the charged electric charges on the photoreceptor 1Y, and is held on a developer roll (developer holding member). In addition, when the surface of the photoreceptor 1Y passes through the developing apparatus 4Y, the yellow toner is electrostatically adhered to the neutralized latent image portion on the surface of the photoreceptor 1Y, and a latent image is developed with the yellow toner. The photoreceptor 1Y on which the yellow toner image is formed subsequently runs at a predetermined rate, and the toner image developed on the photoreceptor 1Y is transported to a predetermined primary transfer position.

When the yellow toner image on the photoreceptor 1Y is transported to the primary transfer position, a predetermined primary transfer bias is applied to the primary transfer roller 5Y, an electrostatic power toward the primary transfer roller 5Y from the photoreceptor 1Y acts on the toner image, and the toner image on the photoreceptor 1Y is transferred onto the intermediate transfer belt 20. The transfer bias applied at this time is a (+) polarity which is a reverse polarity of the (−) polarity of the toner, and is controlled to approximately +10 μA by, for example, the control portion (not shown) in the first unit 10Y.

On the other hand, the toner remaining on the photoreceptor 1Y is removed and collected by the cleaning apparatus 6Y.

In addition, the primary transfer biases applied on the primary transfer rollers 5M, 5C, and 5K after the second unit 10M are also controlled in accordance with the first unit.

In the above manner, the intermediate transfer belt 20 onto which the yellow toner image is transferred by the first unit 10Y is subsequently transported through the second to fourth units 10M, 10C, and 10K, and toner images of the respective colors are superimposed and transferred.

The intermediate transfer belt 20 on which the four-color toner images are transferred through the first to fourth units reaches a secondary transfer portion that is constituted by the intermediate transfer belt 20, the supporting roller 24 that is in contact with the inner surface of the intermediate transfer belt 20, and a secondary transfer roller (secondary transfer unit) 26 disposed on the image holding surface of the intermediate transfer belt 20. On the other hand, recording paper (a transfer medium) P is fed to a gap between the secondary transfer roller 26 and the intermediate transfer belt 20 through a feeding mechanism at a predetermined timing, and a predetermined secondary transfer bias is applied to the supporting roller 24. At this time, the applied transfer bias has a (−) polarity, which is the same as the (−) polarity of the toner, the electrostatic force toward the recording paper P from the intermediate transfer belt 20 acts on the toner image, and the toner image on the intermediate transfer belt 20 is transferred onto the recording paper P. Further, the secondary transfer bias at this time is determined depending on a resistance detected by a resistance detecting unit (not shown) for detecting the resistance of the secondary transfer portion, and is controlled by a voltage.

After that, the recording paper P is sent to a fixing apparatus (fixing unit) 28, the toner image is heated, the multi-colored toner image is fused, and fixed on the recording paper P. The recording paper P on which the color image is completely fixed is transported toward an ejection portion, whereby a series of color image forming operations are completed.

Meanwhile, the image forming apparatus as exemplified above has a configuration in which the toner image is transferred to the recording paper P through the intermediate transfer belt 20, but the image forming apparatus is not limited to this configuration, and may have a structure in which a toner image is directly transferred to the recording paper from the photoreceptor.

<Process Cartridge and Toner Cartridge>

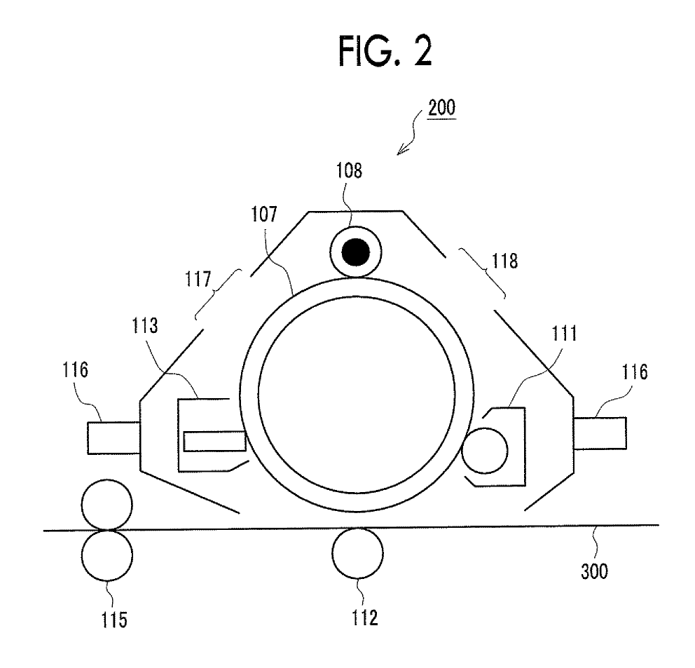

FIG. 2 is a schematic configuration view showing a preferable example of a process cartridge that accommodates the electrostatic image developer of the exemplary embodiment. A process cartridge 200 is an integrated combination of a developing apparatus 111, a charging roller 108, a photoreceptor 107, a photoreceptor cleaning apparatus (cleaning unit) 113, an opening for exposure 118, and an opening for erasing exposure 117, which are combined with an attachment rail 116. In FIG. 2, the symbol 300 indicates a transfer medium.

In addition, the process cartridge 200 may be detachable from the main body of the image forming apparatus which is configured by a transfer apparatus 112, a fixing apparatus 115, and other components, not shown, and configures the image forming apparatus with the main body of the image forming apparatus.

The process cartridge as shown in FIG. 2 has the charging roller 108, the developing apparatus 111, the cleaning apparatus (cleaning unit) 113, the opening for exposure 118, and the opening for erasing exposure 117, and these apparatuses may be selectively combined. The process cartridge of the exemplary embodiment may have at least one selected from a group including the charging roller 108, the photoreceptor 107, the photoreceptor cleaning apparatus (cleaning unit) 113, the opening for exposure 118, and the opening for erasing exposure 117 as well as the developing apparatus 111.

Next, the toner cartridge of the exemplary embodiment will be described. The toner cartridge of the exemplary embodiment is a toner cartridge which is detachable from the image forming apparatus, and at least accommodates a toner that is supplied to the developing unit provided in the image forming apparatus, in which the toner of the exemplary embodiment is used as the toner. Meanwhile, the toner cartridge of the exemplary embodiment may accommodate at least the toner, or may accommodate, for example, a developer using a mechanism of the image forming apparatus.

Therefore, in the image forming apparatus having a configuration from which the toner cartridge may be detachable, the toner of the exemplary embodiment is easily supplied to the developing apparatus using the toner cartridge accommodating the toner of the exemplary embodiment.

Meanwhile, the image forming apparatus as shown in FIG. 1 is an image forming apparatus having a configuration in which the toner cartridges 8Y, 8M, 8C, and 8K are attached and detached, and the developing apparatuses 4Y, 4M, 4C, and 4K are connected to the toner cartridges corresponding to the respective developing apparatuses (colors) through toner supplying tubes, not shown. In addition, in a case in which the toners accommodated in the toner cartridges become low, the toner cartridges are replaced.

### EXAMPLES

Hereinafter, the exemplary embodiment will be described in more detail with reference to Examples and Comparative Examples, but the exemplary embodiment is not limited to the examples. Further, “parts” and “%” are mass standards unless otherwise described.

### Example 1

84.5 parts of methanol and 15.5 parts of 10% aqueous ammonia solution are mixed in a 3 L glass reaction vessel (the inside diameter of the vessel: 16 cm) equipped with a stirrer, two dropping nozzles, and a thermometer, and a mixed solution (preliminary mixed solution) is adjusted to 25° C. The ammonia concentration at this time is 0.744 mol/L. After the temperature of the preliminary mixed solution reaches 25° C., dropping of a total of 1.32 parts/min of tetramethoxysilane (TMOS) with respect to the preliminary mixed solution and a total of 0.50 part/min of the 6.0% aqueous ammonia solution with respect to the preliminary mixed solution is started from the two dropping nozzles, and the dropping is continued for 29 minutes, thereby producing a suspension of silica particles 1. The distance between the dropping locations of the two dropping nozzles is 15 cm.

The volume average particle diameter of the silica particles 1 at this time is 140 nm. After that, 84.5 parts, which is the same amount as methanol, of the solvent is distilled away through heating distillation, the equivalent 84.5 parts of deionized water (DIW) is added, and the mixture is dried using a freeze dryer, thereby producing hydrophilic silica particles 1. Furthermore, after 50 parts of trimethylsilane is added to the hydrophilic silica particles 1, the mixture is heated to 150° C. while being stirred, and heating-reacted for 2 hours, thereby producing hydrophobic silica particles 1. The silica particles 1 are observed using a scanning electron microscope, and an image analysis is carried out so that the average degree of circularity and the geometric standard deviation of the degree of circularity are obtained. The results are shown in Table 2.

### Examples 2 to 5 and Comparative Examples 1 to 4

Hydrophobic silica particles 2 to 9 according to Examples 2 to 5 and Comparative Examples 1 to 4 are obtained in the same manner as in Example 1 except that the preliminary mixed solution and post dropping components as described in Table 1 are used. The volume average particle diameter, average degree of circularity, and geometric standard deviation of the degree of circularity of the obtained silica particles are shown in Table 2.

### Example 6

### Manufacturing of the Toner

(Preparation of resin particle dispersion)

A mixture of 285 parts of styrene, 115 parts of n-butyl acrylate, 8 parts of an acrylic acid, and 24 parts of dodecanthiol is emulsified in a flask containing 6 parts of a nonionic surfactant (NONIPOL 400: manufactured by Sanyo Chemical Industries, Ltd.) and 10 parts of an anionic surfactant (NEOGEN SC: manufactured by Dai-ichi Kogyo Seiyaku Co., Ltd.) dissolved in 550 parts of ion-exchange water, 50 parts of ion-exchange water having 4 parts of ammonium persulfate dissolved therein is injected to the solution while the solution is slowly mixed for 10 minutes. After nitrogen substitution, the solution is heated to 70° C. in an oil bath while the solution is stirred in the flask, and emulsification polymerization continues for 5 hours as the solution is. As a result, a resin particle dispersion in which resin particles having an average particle diameter of 150 nm, a glass transition temperature (Tg) of 53° C., and a weight average molecular weight Mw of 32000 are dispersed is obtained. The solid content concentration of the dispersion is 40%.

(Preparation of the Colorant Dispersion)

Cyan pigment (C.I. Pigment Blue 15:3); 60 parts

Nonionic surfactant (NONIPOL 400: manufactured by Sanyo Chemical Industries, Ltd.); 5 parts

Ion-exchange water: 240 parts

The above components are mixed, stirred for 10 minutes using a homogenizer (ULTRA-TURRAX, manufactured by IKA), and then dispersed using an altimizer, thereby preparing a colorant dispersion in which colorant (Cyan pigment) particles having an average particle diameter of 250 nm are dispersed.

(Preparation of Release Agent Dispersion)

Paraffin wax HNP9 (manufactured by Nippon Seiro Co., Ltd., fusion temperature: 75° C.): 45 parts

Cationic surfactant Neogen RK (manufactured by Dai-ichi Kogyo Seiyaku Co., Ltd.): 5 parts

Ion-exchange water: 200 parts

The above components are mixed, heated to 100° C., dispersed in ULTRA-TURRAX T50 manufactured by IKA, and then dispersed using a pressure-ejection type Gaulin homogenizer, thereby producing a release agent dispersion in which release agent particles have a median diameter of 196 nm and a solid content amount of 22.0%.

(Preparation of the Toner Particles)

Resin particle dispersion 234 parts Colorant dispersion 30 parts

Release agent dispersion 40 parts

Poly aluminum hydroxide (Paho2S, manufactured by Asada

Chemical Industry Co., Ltd.) 0.5 part

Ion-exchange water 600 parts

The above components are mixed in a round stainless steel flask using a homogenizer (ULTRA-TURRAX T50 manufactured by IKA), dispersed, and then heated to 40° C. while the solution is stirred in a heating oil bath. After holding the solution at 40° C. for 30 minutes, it is confirmed that agglomeration particles having an average particle diameter (D50) of 4.5 μm are formed. Furthermore, the temperature of the heating oil bath is increased to 56° C. and held for 1 hour, then, the D50 becomes 5.3 μm. After that, 26 parts of a resin particle dispersion is added to the dispersion including the agglomeration particles, the heating oil bath is held at a temperature of 50° C. for 30 minutes. 1N sodium hydroxide is added to the dispersion including the agglomeration particles, the pH of the system is adjusted to 5.0, then the stainless steel flask is sealed using a magnetic seal, the mixture is heated to 95° C. while being continuously stirred, and held for 4 hours. After cooling, toner particles are filtered, washed four times using ion-exchange water, and then freeze-dried, thereby producing toner particles. The D50 of the toner particles is 5.8 μm, and the average degree of circularity is 0.96.

5 parts of the silica particles 1 is added to 100 parts of the toner particles as an external additive, and mixed for minutes using a Henschel mixer. Furthermore, the mixture is sieved using an ultrasonic shaking sieve (45 μm, manufactured by Dalton Co., Ltd.) so as to obtain the toner 1.

<Production of Carrier>

Ferrite particles (volume average particle diameter; 35 μm): 100 parts

Toluene: 14 parts

Perfluoro acrylate copolymer (critical surface tension

24 dyn/cm): 1.6 parts

Carbon black (product name: VXC-72, manufactured by Cabot Corp., resistance of 100 Ω·cm or less): 0.12 part

Crosslinked melamine resin particles (volume average particle diameter; 0.3 μm, toluene-insoluble): 0.3 part

The components excluding ferrite particles are dispersed for 10 minutes using a stirrer so as to prepare a coating layer-forming solution. Furthermore, the coating layer-forming solution and ferrite particles are put into a vacuum degassing kneader, stirred for 30 minutes at 60° C., and then depressurized so as to distill away the toluene and form a resin coating layer, thereby producing a carrier. (However, in the perfluoro acrylate copolymer which is a carrier resin, the carbon black is diluted by the toluene, and dispersed using a sand mill in advance.)

<Production of the Developer>

After 8 parts of the toner 1 and 92 parts of the carrier are put and stirred in a V blender for 20 minutes, the mixture is sieved using a 105 μm-mesh sieve, thereby producing an electrostatic image developer.

<Filming Evaluation>

Using a modified DocuPrint C3200 (manufactured by Fuji Xerox Co., Ltd.) filled with the electrostatic image developer (the process speed is set to 350 mm/sec, and modification is made so that the printer operates as usual through transfer even when the fixing apparatus is removed), 7000 sheets are continuously printed at 10° C. under a 20% RH environment with a toner amount on a recording medium of 0.15 g/m², then 5000 sheets are continuously printed at 28° C. and under a 85% RH environment with a toner amount of 0.15 g/m², the number of printed sheets on which image defects occur due to filming is digitalized by percentage. The results are shown in Table 2.

A: less than 0.5%
B: 0.5% to less than 1.0%
C, 1.0% to less than 5.0%
D: 5.0% or more

<Transfer Durability Evaluation>

The developing device in the modified DocuPrint C3200 is filled with the electrostatic image developer, mixed charts of solid images and characters are continuously printed on 7000 sheets under conditions of at 10° C., a 20% RH environment, and a process speed of 350 mm/sec, residual substances on the surface of the photoreceptor are visually observed using tape transfer, and evaluation is made based on the following criteria.

A: No transfer residue
B: Transfer residue exists, but is not visually observed.
C: A few transfer residue portions are detected, and cause problems in practice.
D: A large amount of transfer residue exists, and causes significant problems in practice, which makes the toner inappropriate.

### Examples 6 to 10 and Comparative Examples 5 to 8

Toners and developers are prepared in the same manner as in Example 6 except that the silica particles 2 to 9 are used instead of the silica particles 1, and evaluated. The obtained results are shown in Table 2.

### Example 11

### Preparation of the Toner

Resin particle dispersion 234 parts

Colorant dispersion 30 parts

Release agent dispersion 40 parts

Poly aluminum hydroxide (Paho2S, manufactured by Asada

Chemical Industry Co., Ltd.) 0.5 part

Ion-exchange water 600 parts

The above components are mixed in a round stainless steel flask using a homogenizer (ULTRA-TURRAX T50 manufactured by IKA), dispersed, and then heated to 40° C. while the solution is stirred in a heating oil bath. After holding the solution at 40° C. for 30 minutes, it is confirmed that agglomeration particles having an average particle diameter (D50) of 4.5 μm are formed. Furthermore, the temperature of the heating oil bath is increased to 56° C. and held for 1 hour, then, the D50 becomes 5.3 μm. After that, 26 parts of a resin particle dispersion is added to the dispersion including the agglomeration particles, the heating oil bath is held at a temperature of 50° C. for 30 minutes. 1N sodium hydroxide is added to the dispersion including the agglomeration particles, the pH of the system is adjusted to 5.0, then the stainless steel flask is sealed, the mixture is heated to 95° C. while being continuously stirred using a magnetic seal, and held for 3.2 hours. After cooling, toner particles are filtered, washed four times using ion-exchange water, and then freeze-dried, thereby producing toner particles. The D50 of the toner particles is 5.8 μm, and the average degree of circularity is 0.94.

A toner and a developer are prepared in the same manner as in Example 6 except that the toner particles having an average degree of circularity of 0.94, which are obtained in the above manner, are used, and evaluated. The obtained results are shown in Table 2.

### Comparative Example 9

A toner and a developer are prepared in the same manner as in Example 6 except that silica particles (RY 50, manufactured by AEROSIL Co., Ltd.) are used instead of the silica particles 1, and evaluated. The obtained results are shown in Table 2.

TABLE 1

| | | | | | | | Post dropping components | | | |
|---|---|---|---|---|---|---|---|---|---|---|
| | | Preliminary mixed solution | | | | | | | 6% aqueous | |
| | | | | 10% aqueous | | Ammonia | TMOS drop | TMOS drop | ammonia drop | Dropping |
| | Silica | Temp. | Methanol | ammonia | DIW | conc. | amount 1 | amount 2 | amount | time |
| | No. | [° C.] | [parts] | [parts] | [parts] | [mol/L] | (parts/min) | (parts/min) | (parts/min.) | [min] |
| Example 1 | 1 | 25 | 84.5 | 15.5 | 0 | 0.744 | 0.66 | 0.66 | 0.50 | 29 |
| Example 2 | 2 | 31 | 84.5 | 15.5 | 0 | 0.744 | 0.84 | 0.84 | 0.63 | 18 |
| Example 3 | 3 | 20 | 84.5 | 15.5 | 0 | 0.744 | 0.48 | 0.48 | 0.36 | 75 |
| Example 4 | 4 | 21 | 84.0 | 13.0 | 3.0 | 0.623 | 0.56 | 0.56 | 0.36 | 33 |
| Example 5 | 5 | 25 | 84.5 | 15.5 | 0 | 0.742 | 1.80 | 0.48 | 0.86 | 21 |
| Comparative | 6 | 33 | 84.5 | 15.5 | 0 | 0.744 | 0.7 | 0.7 | 0.7 | 20 |
| Example 1 | | | | | | | | | | |
| Comparative | 7 | 18 | 84.5 | 15.5 | 0 | 0.744 | 0.3 | 0.3 | 0.3 | 85 |
| Example 2 | | | | | | | | | | |
| Comparative | 8 | 25 | 70.0 | 15.0 | 15.0 | 0.741 | 0.25 | 0.25 | 0.25 | 180 |
| Example 3 | | | | | | | | | | |
| Comparative | 9 | 22 | 84.0 | 13.0 | 3.0 | 0.623 | 2.5 | 0.3 | 1.2 | 14 |
| Example 4 | | | | | | | | | | |

TABLE 2

| | Silica particles | | | | | | |
|---|---|---|---|---|---|---|---|
| | | | | Geometric | | | |
| | | Volume | | standard | Toner | | |
| | | average | Average | deviation of | Average | Evaluation | |
| | | particle | degree of | degree of | degree of | | Transfer |
| | Silica No. | diameter/nm | circularity | circularity | circularity | Filming | durability |
| Example 6 | 1 | 140 | 0.930 | 1.10 | 0.96 | A | A |
| Example 7 | 2 | 85 | 0.930 | 1.13 | 0.96 | A | B |
| Example 8 | 3 | 290 | 0.930 | 1.09 | 0.96 | B | A |
| Example 9 | 4 | 143 | 0.935 | 1.03 | 0.96 | B | B |
| Example 10 | 5 | 132 | 0.920 | 1.15 | 0.96 | B | B |
| Comparative | 6 | 76 | 0.940 | 1.11 | 0.96 | C | D |
| Example 5 | | | | | | | |
| Comparative | 7 | 320 | 0.955 | 1.06 | 0.96 | D | B |
| Example 6 | | | | | | | |
| Comparative | 8 | 142 | 0.962 | 1.01 | 0.96 | C | C |
| Example 7 | | | | | | | |
| Comparative | 9 | 140 | 0.900 | 1.16 | 0.96 | C | C |
| Example 8 | | | | | | | |
| Example 11 | 1 | 140 | 0.930 | 1.10 | 0.94 | C | B |
| Comparative | Commercially | 97 | 0.700 | 1.18 | 0.96 | C | D |
| Example 9 | available | | | | | | |
| | product | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. Silica particles comprising,
the silica particles having a volume average particle diameter in a range of from about 80 nm to about 300 nm, an average degree of circularity in a range of from about 0.920 to about 0.935, and a geometric standard deviation of the degree of circularity in a range of from about 1.02 to about 1.15.

2. The silica particles according to claim 1,
wherein a volume average particle diameter is in a range of from about 100 nm to about 200 nm.

3. The silica particles according to claim 1,
wherein a volume average particle diameter is in a range of from about 100 nm to about 150 nm.

4. The silica particles according to claim 1,
wherein an average degree of circularity is in a range of from about 0.920 to about 0.930.

5. The silica particles according to claim 1,
wherein a geometric standard deviation of the degree of circularity is in a range of from about 1.10 to about 1.15.

6. The silica particle according to claim 1, which is treated with a hydrophobizing agent.

7. An electrostatic image developing toner comprising:
toner particles containing a binder resin; and
an external additive,
wherein the toner particles have an average degree of circularity of about 0.96 or more, and
the external additive is the silica particles according to claim 1.

8. The electrostatic image developing toner according to claim 7,
wherein an average degree of circularity of the toner particles is about 0.97 or more.

9. The electrostatic image developing toner according to claim 7,
wherein a volume average particle diameter of the silica particles is in a range of from about 100 nm to about 200 nm.

10. The electrostatic image developing toner according to claim 7,
wherein an average degree of circularity of the silica particles is in a range of from about 0.920 to about 0.930.

11. The electrostatic image developing toner according to claim 7,
wherein a geometric standard deviation of the degree of circularity of the silica particles is in a range of from about 1.10 to about 1.15.

12. A developer for developing electrostatic images comprising the electrostatic image developing toner according to claim 7.

13. The developer for developing electrostatic images according to claim 12,
wherein a volume average particle diameter of the silica particles is in a range of from about 100 nm to about 200 nm.

14. The developer for developing electrostatic images according to claim 12,
wherein an average degree of circularity of the silica particles is in a range of from about 0.920 to about 0.930.

15. An image forming method comprising:
charging a surface of an image holding member;
forming an electrostatic latent image on the surface of the image holding member;
developing the electrostatic latent image formed on the surface of the image holding member by using a developer to form a toner image; and
transferring the developed toner image to a transfer medium,
wherein the developer is the electrostatic image developer according to claim 12.

16. The image forming method according to claim 15,
wherein a volume average particle diameter of the silica particles is in a range of from about 100 nm to about 200 nm.

17. The image forming method according to claim 15,
wherein an average degree of circularity of the silica particles is in a range of from about 0.920 to about 0.930.
